(19) United States
(12) Patent Application Publication
(10) Pub. No.: US 2020/0094849 A1
(43) Pub. Date: Mar. 26, 2020

(54) METHOD FOR QUANTITATIVELY CHARACTERIZING AT LEAST ONE TEMPORAL SEQUENCE OF AN OBJECT ATTRIBUTE ERROR OF AN OBJECT

(71) Applicant: Robert Bosch GmbH, Stuttgart (DE)

(72) Inventors: Patrick Weber, Kornwestheim (DE); Achim Feyerabend, Heilbronn (DE); Lars Wagner, Leonberg (DE); Thomas Grosser, Talheim (DE)

(21) Appl. No.: 16/577,335

(22) Filed: Sep. 20, 2019

(30) Foreign Application Priority Data
Sep. 26, 2018 (DE) 102018216420.7
Aug. 22, 2019 (DE) 102019212602.2

(51) Int. Cl. B60W 50/02; B60W 30/095; B60W 50/04; G06K 9/00

(52) U.S. Cl. CPC B60W 50/0205; B60W 30/0956; B60W 2050/0028; G06K 9/00805; B60W 50/045

(57) ABSTRACT

A method for quantitatively characterizing at least one temporal-sequence (TS) of an object-attribute-error of an object, for at least one scenario of a plurality of scenarios; the object having been detected by a sensor of a plurality of sensors; including: providing at least one TS of sensor-data of a plurality of TSs of sensor-data of the sensor, for the at least one scenario; determining a TS of at least one object-attribute of the object with the TS of sensor-data; providing a sequence of a reference-object-attribute of the object of the scenario, corresponding to the TS of the object-attributes; determining a sequence of object-attribute-difference by comparing the sequence of the object-attribute to the sequence of the reference-object-attribute of the object; generating an error-model for describing TSs of object-attribute-errors of objects; the object having been detected by the sensor, with the TS of the object-attribute-difference, to quantitatively characterize the object-attribute-error.

### RELATED APPLICATION INFORMATION

The present application claims priority to and the benefit of German patent application no. DE 10 2018 216 420.7, which was filed in Germany on Sep. 26, 2018, and German patent application no. DE 10 2019 212 602.2, which was filed in Germany on Aug. 22, 2019, the disclosures of which are incorporated herein by reference.

### FIELD OF THE INVENTION

The present invention relates to a method for quantitatively characterizing at least one temporal sequence of an object attribute error of an object, for at least one scenario of a plurality of scenarios; the object having been detected by at least one sensor of a plurality of sensors.

### BACKGROUND INFORMATION

For releasing highly or at least partially automated vehicles, in particular, having pilot functions of the automation level 3 or higher (according to the standard SAE J3016), the testing for a release operation of a control system of the at least partially automated vehicle constitutes a particular challenge. The reason for this is that first of all, such systems are extremely complex, and secondly, the systems are subjected to so-called open world or open context situations in the field. In detail, this means that the exact make-up (participants, roadway, maneuver, etc.) of the driving situations and their execution during the development operation may only be guaranteed to a limited extent. Some situations may only be detected with high demands on the capacity of the test system, which sometimes results in the limitation of the test coverage, as well.

### SUMMARY OF THE INVENTION

Existing test methods for a control system of the at least partially automated vehicle are not able to consider all aspects of such a test simultaneously:

a) long-term test runs of the entire control system, for example, in the highway space, which are carried out at the end of the development, or even during the development process of the system, as well, may only cover driving distances on the order of 10⁴ km, due to practical and economic reasons. Thus, interesting and, in some instances, particularly critical situations are often underrepresented.

b) Testing on test tracks may indeed simulate some interesting situations, but regarding the distance traveled, they have the same problems as continuous runs, since the specific remodeling of the scenario is highly time-consuming and expensive. In addition, some scenarios may not be implemented on test tracks.

c) An evaluation of trials using a plurality of sensors and the control system, on the basis of labeled data, that is, in comparison with ground-truth data, only provides incomplete information regarding the reaction of the entire system after the optimization of the algorithms. The method neglects the aspect of feedback; that is, a different progression of the scenario, due to system behavior different from that in the original measurement, is not possible.

d) Virtual simulation trips of the entire automated system, thus, including simulated vehicle dynamics, in the form of software in the loop (SiL) with a coupled world simulation, are, for example, indeed scalable to 10⁵-10⁷ km, depending on the degree of detail, and may simulate, in particular, interesting situations, but are highly limited in modeling realistic measurement data of, for example, sensors, which are configured for representing the surrounding area of the vehicle. The required chassis systems control sensor models are often not available and/or may only be validated with difficulty, and may only be integrated into the world simulation at great expense and with a loss of performance.

The present invention provides a method for quantitatively characterizing at least one temporal sequence of an object attribute error of an object, a device, a computer program, as well as a machine-readable storage medium according to the features of the descriptions herein, which achieve the above-mentioned objects at least partially. Advantageous refinements are the subject matter of the further descriptions herein, as well as of the following description.

The present invention is based on the finding that measured, temporal sequences of object attribute errors of objects, which have been detected with the aid of a sensor, may be simulated effectively as a function of sensor type and correspondingly different scenarios, with the aid of statistical error models. This also yields the possibility of superposing sequences of error values generated in this manner, on ideal temporal sequences of object attributes of objects, in order to be able to simulate object attribute errors of the relevant objects realistically.

According to one aspect, a method for quantitatively characterizing at least one temporal sequence of an object attribute error of an object, for at least one scenario of a plurality of scenarios, is put forward; the object having been detected by at least one sensor of a plurality of sensors.

In one step, at least one temporal sequence of sensor data of a plurality of temporal sequences of sensor data of the at least one sensor is provided for the at least one scenario.

In a further step, at least one temporal sequence of at least one object attribute of the object is determined with the aid of the at least one temporal sequence of sensor data.

In a further step, a sequence of a reference object attribute of the object of the scenario, corresponding to the temporal sequence of the object attributes, is provided.

In a further step of the method, a sequence of object attribute difference is determined by comparing the sequence of the object attribute to the sequence of the reference object attribute of the object for the scenario.

In a further step, an error model is generated with the aid of the temporal sequence of the object attribute difference, in order to describe temporal sequences of object attribute errors of objects for the scenario; the object having been detected by the at least one sensor, in order to quantitatively characterize the object attribute error.

Using this method, realistic errors, which are derived from data sequences actually recorded, may be provided, in order to use them, for example, in a simulation for validating vehicle control systems. To that end, sequences of these errors are superposed on object attributes of synthetic objects, in order to be able to check the influence of the errors of the object attributes in the simulation.

According to one aspect, it is provided that the time base of the at least one temporal sequence of at least one object attribute of the object and the time base of the temporal sequence of a reference object attribute, corresponding to the temporal sequence of the object attributes, be adapted to each other prior to the determination of the object attribute difference, in order to calculate the difference. In particular, these two time bases may be adapted to each other, since they are adapted to a common, equidistant time base.

By using a common time base, a multitude of different sensor types and a multitude of reference object attributes may be compared to each other, in order to derive an object attribute error from this.

According to one aspect, it is provided that in order to quantitatively characterize at least one temporal sequence of an object attribute error, the object be detected by a plurality of sensors.

In one step, at least one temporal sequence of a plurality of temporal sequences of sensor data of each sensor of the plurality of sensors is provided for the at least one scenario.

In a further step, of at least one temporal sequence of at least one object attribute of the object is determined with the aid of the at least one temporal data sequence of each sensor of the plurality of sensors.

In a further step, the resulting plurality of temporal sequences of the object attributes of the object is merged with the aid of the individual object attributes of the plurality of sensors.

In a further step, a sequence of a reference object attribute of the object of the scenario, corresponding to the temporal sequence of the object attributes, is provided.

In a further step, a sequence of an object attribute difference is determined by comparing the sequence of the merged object attributes to the sequence of the reference object attributes of the object for the scenario.

In a further step, an error model is generated with the aid of the sequence of the merged object attribute difference, in order to describe temporal sequences of the object attribute errors of objects for the scenario; the object having been detected by the plurality of sensors, in order to quantitatively characterize the object attribute error.

Generating an error model with the aid of the temporal sequence of the object attribute difference, in order to describe temporal sequences of object attribute errors of objects for the scenario; the object having been detected by the at least one sensor, in order to quantitatively characterize the object attribute error.

Consequently, the object attribute error, or also the sensor noise and/or the sensor error on the level of the typical attributes of the objects detected by an individual sensor, as well as the object detected by a plurality of sensors, are ascertained with the aid of the merged objects, that is, prior to and after the merging of sensor data. Thus, the object attribute difference is also ascertained for object attributes of merged sensor data. This may improve the accuracy of the object attributes of the objects.

The object attribute error, that is, the sensor noise, is ascertained on the level of the typical object attributes of the individual sensor objects and on the level of the merged objects, thus, prior to and after the merging of sensor data.

In the following, the method steps are summarized once more, using different words:

The attribute differences/deltas of the ground truth estimate (GTE) and of the vehicle under test (VuT) are converted to a common time base.

Since GTE and VuT generally do not have a common time base, the two must be converted to a common time base. A possible time base is equidistant temporal sampling at an interval dt; however, other methods of adapting the two time bases are also possible.

Thus, the resampling of GTE and VuT onto a common time base at an equidistant temporal interval dt follows.

GTE and VuT may then be assigned for a 1:1 assignment algorithm, in order to calculate an attribute delta. In this context, each dynamic GTE/VuT object may be assigned, in each instance, to, at most, one dynamic VuT/GTE object. Association algorithms already present, from the metric computation module, are used for this assignment. Different interval measures between dynamic objects may be used for the assignments, that is, each dynamic GTE/VuT object may be assigned, in each instance, to, at most, one dynamic VuT/GTE object. In this context, the gating and the distance measurement are parameterized.

If, using the data, there are more VuT objects than GTE objects (e.g., ghosts), then some VuT objects are not considered. Finally, the attribute deltas between dynamic GTE and VuT objects may be calculated.

Comment: it should be taken into account that the association algorithm, as well as parameters of this algorithm, such as a threshold gating value, have an influence on the error modeling. This must be taken into account in the generation of the noise in the simulation, since it is not necessarily clear which noise is the “correct” noise, that is, which model correctly represents the actual, real noise.

In this connection, it should also be considered that the noise, which is modeled as described, only represents the accuracy of the objects, not the integrity (in the sense of accuracy and integrity metrics).

The calculation of the delta of the specified attributes takes place for each GTE state, which is assigned. Calculation of attribute differences/deltas between GTE and VuT.

According to a further aspect, it is proposed that the provided, associated sequence of reference object attributes of the object of the scenario be generated with the aid of a manual labeling method and/or reference sensor system and/or the hunter-rabbit method and/or algorithmic methods for generating reference data, that is, a holistic generation of reference labels, which considers both the past and the future of the data, and/or highly precise map data.

To generate reference object attributes, using the different methods, in each instance, a suitable method, which best fits the circumstances, may be selected. In this context, in particular, the method including the reference sensors is to be emphasized, since in this case, sequences of object attributes of objects may be determined, using the vehicle sensor system, and sequences of reference object attributes of objects may be determined, using the reference sensors adapted additionally to the vehicle.

According to one aspect, it is provided that at least one scenario of the plurality of scenarios be divided up into categories typical of a scenario, and that each category be assigned a corresponding error model.

According to a further aspect, it is provided that the scenarios include sub-scenarios, and that the categories be assigned to the scenarios and sub-scenarios in such a manner, that the categories are encoded in an associable manner.

Thus, for each scenario and corresponding sub-scenarios, the correspondingly correct categories may be chosen, in order to be able to select a suitable error model. Examples of such categories would be a vehicle traveling ahead, a vehicle in the adjacent lane, pedestrians, who are approaching the roadway, etc.

Thus, using the different, specific, scenario-typical category, the corresponding object attribute error, that is, the corresponding Monte Carlo noise, is selected, which may then be superposed on the synthetic object attributes. In this context, the categories may also be constructed hierarchically. Consequently, the specific category is freely filterable and category, and the associated object attribute error may be stored, for example, in an associative memory. In particular, traffic scenarios or sensor application scenarios are meant by the scenarios.

According to one aspect, it is provided that the error model be configured to generate temporal sequences of the object attribute errors specifically for scenarios of a plurality of scenarios having a temporal amplitude behavior of the sequence of the object attribute difference and/or a correlation behavior of the sequence of the object attribute difference and/or a dynamic behavior of the sequence of the object attribute difference.

Using this method, scenario-specific object attribute errors may be superposed on synthetically generated object attributes; with regard to their statistical values, the scenario-specific, object attribute errors corresponding to a measured object attribute difference.

According to one aspect, it is provided that the error model generate the temporal sequence of the object attribute error for a scenario, using a statistical method, in which with the aid of a probability density and a random walk, a sequence of object attribute errors is generated on the probability density; and by thinning out the temporal sequence of object attribute errors, the autocorrelation length is adapted to the sequence of the object attribute difference; and with the aid of a density estimator and a plurality of temporal sequences of object attribute differences of a plurality of different object attributes of the scenario, the probability density common to the plurality of object attributes is generated.

Consequently, this produces a situation-specific and realistic impairment of the performance of the sensors, which may be implemented by the object attribute error with regard to amplitude, correlation and dynamic behavior in key scenarios.

According to one aspect, the error model is configured to generate temporal sequences of an existence probability of at least one object of the surrounding area.

The statistics about the noise and/or the errors in the attributes include, e.g., position and velocity errors, but also existence probabilities of objects as a function of different sensor characteristics, influence factors, such as velocity, traffic scenario, etc., and environmental influences, such as visibility, weather, etc.

A method according to the descriptions herein, for validating a vehicle control system (175) in a simulation, using at least one scenario of a plurality of scenarios in a simulation environment is provided; the simulation environment including at least one object, and in one step, the method providing at least one temporal sequence of sensor data of at least one sensor for a representation of the at least one object, in accordance with the scenario. In a further step, a temporal sequence of at least one object attribute of the at least one object is determined with the aid of the at least one temporal sequence of sensor data. In a further step, an error model of the at least one sensor is provided in accordance with a type of the at least one sensor, and in accordance with the scenario.

In a further step, a temporal sequence of an object attribute error is generated, using the error model for the at least one object attribute of the at least one object.

In a further step, the temporal sequence of the object attribute error is superposed on the temporal sequence of the at least one object attribute of the at least one object.

In a further step, the temporal sequence of the at least one object attribute, including the superposed error contribution for the vehicle control system, is provided for validating the vehicle control system in the scenario.

In this context, the term validation of a vehicle control system also includes a verification of a vehicle control system, which means that in this connection, the term validation may also be replaced with the term verification, and vice versa.

Using this method, it is possible to implement specific scenarios in a simulation, and with the feeding-in of realistic errors, which are superposed on the object attributes, and with reference to their statistical characterization, it is possible to correspond to object attributes from sensor data actually recorded.

In this method, in the simulated world, a vehicle is driven by a real vehicle control unit and, therefore, may be tested and verified highly specifically.

A method according to the descriptions herein, for validating a vehicle control system in a vehicle, in a surrounding area that includes at least one object, is provided. In the case of this method, in one step, at least one temporal sequence of sensor data of at least one reference sensor is determined in order to detect the at least one object of the surrounding area. In a further step, a temporal sequence of at least one object attribute of the at least one object is determined with the aid of the at least one temporal sequence of the sensor data.

In a further step, the scenario of the surrounding area of the vehicle is identified, using the at least one temporal sequence of the sensor data.

In one further step, an error model is provided in accordance with a type of test sensor, and in accordance with the identified scenario.

In a further step of the method, a temporal sequence of an object attribute error is generated, using the error model for the at least one object attribute of the at least one object.

In a further step, the temporal sequence of the object attribute error is superposed on the temporal sequence of the at least one object attribute of the at least one object.

In a further step, the temporal sequence of the at least one object attribute, including the superposed error contribution for the vehicle control system, is provided for validating the vehicle control system in the vehicle.

By representing the handling of real vehicles and/or real vehicle functions in the real world, a higher level of meaningfulness may possibly be generated than in the case of the pure simulation, using these error models. In this case, the handling functions on the vehicle level, and not exclusively in the simulation environment; the deployment in the simulation probably being able to measure larger random samples and providing perfect environmental conditions.

A control system of a vehicle includes a computer system having a memory, and furthermore, a list of scenarios that is stored in the memory. The vehicle is, in particular, a land vehicle. The scenarios are, for example, a predefined number of test scenarios, which are also used, e.g., for regression tests.

In addition, the control system includes a plurality of sensors; each of the sensors being configured to transmit a measured value to the memory. Sensors include, e.g., cameras, radar, lidar or ultrasonic sensors. The sensors are used, e.g., to determine so-called dynamic labels, in order to determine, for example, ground truth estimates. Dynamic labels describe attributes of both the ego vehicle and other objects, such as, in particular, other vehicles of a surrounding area. Such object attributes include, in particular, e.g., a position, an orientation, a speed or an acceleration of an object.

The control system also includes a first program, which is set up, for each of the scenarios and for each of the sensors, to assign the measured value from the sensors and to determine a corresponding error value. The error value denotes the deviation from a reference value, which is regarded as correct (ground truth estimate).

The first program may be executed on the computer system, or also on a server. In one specific embodiment, the first program is executed prior to real-time computations.

The measured value may be a single measured value or a list of measured values or, in other words, a sequence of measured values and/or a sequence of data, which could form, in particular, a consecutive temporal sequence. The error value is assigned to each individual measured value. The error value may be an individual value or, for example, a value including statistical information, such as the distribution function (such as a Gaussian distribution) and the standard deviation, or also a list including measured errors or, in other words, a temporal sequence of error values. The error value, that is, in particular, the sequence of errors, may be stored in a database, e.g., on a server or a database in the vehicle, and/or may be determined continuously or intermittently.

In addition, the control system includes a second program, which is set up to determine, for each of the scenarios, a merged value from the measured values of a plurality of sensors. In particular, this merged value may be calculated, using object attributes and/or objects, which have been generated with the aid of data of the individual sensors, or directly as a merged object, using the measured values of the plurality of sensors.

The second program may be executed on the computer system. The second program carries out so-called object generation. In this context, objects are formed from the measured values of the plurality of sensors, and, in some instances, using further data (e.g., from a database). These formed objects are an equivalent to objects of the real world, e.g., roads, buildings, other vehicles, for representing the surrounding area. The object generation is occasionally referred to as world simulation, as well. A list of the generated objects and the merged objects is part of the so-called environment model, that is, the surrounding area. Furthermore, the environment model may include a traffic lane model and/or the description of further environmental conditions, such as weather, visibility, road condition.

A situation and/or scene of a world simulation is a synthetic, that is, in particular, a simulated environment, e.g., a modeled highway intersection, including roads, guardrails, bridges and other road users, whose behavior is simulated, as well. This simulated or synthetic environment may be used as a substitute for sensor data from the real world. In place of, or in addition to detected, real objects, synthetic objects of the world simulation formed in this manner may be fed into a sensor data merging unit or into further modules of an automated vehicle. The, e.g., simulated agents in the world simulation, e.g., other road users, may interact with the simulated, at least partially automated vehicle.

The control system also includes a third program, which is set up to determine a corresponding merging error for each merged value. In this context, such a merging error is an error, which relates to object attributes of objects that have been determined by merging sensor data. In addition, the third program may also determine errors, which relate to object attributes, whose objects have been generated, using only the data of a sensor. Thus, statistical dimension numbers, such as means (arithmetical) or variance of the merging errors, are a reflection of an agglomeration of measured values onto a considerably lower number of values, in some specific embodiments, onto a single value, and are derived from the measured values or data sequences of the sensors, that is, of the plurality of sensors. The considerably lower number of values may be determined, for example, with the aid of a standard deviation function (hash function). The standard deviation function may be injective.

In this manner, operating values may be determined considerably more rapidly and simply. Consequently, it is also possible to adapt error-containing, measured values of a real system to the control system of vehicles. Furthermore, with the scenarios and the rapid algorithmic access to these scenarios, there is an extensive basis for tests, e.g., for regression tests.

In one specific embodiment, the control system further includes a fourth program, which is set up to determine a corrected, merged value for each of the scenarios. Thus, the fourth program identifies a particular scenario and determines the corrected, merged value from it. From the point of view of the fourth program, one scenario may be determined, for example, by a number of measured values from the plurality of sensors, or additionally by a number of error values from the plurality of sensors. In one specific embodiment, the scenario is determined by the resulting values of the standard deviation function, which was determined by the third program.

This consequently provides a computationally efficient and storage-efficient option for testing vehicle components or the entire vehicle. In addition, the control unit of the vehicle may therefore use the real sensor data in a highly efficient manner.

In one specific embodiment, the fourth program is set up to determine a corrected, merged value for each of the scenarios, using an associative memory. In this manner, the access to the sensor values and error values becomes more rapid, which is advantageous, in particular, in the case of real-time requests. This may also accelerate the detection of the scenarios.

The present invention also includes a method for controlling a vehicle with the aid of a control system, according to one of the preceding descriptions, the method including the steps:
Generating a list of scenarios and storing it in a memory.
For each of the scenarios, determining measured values with the aid of a plurality of sensors, and corresponding error values with the aid of a first program.

Consequently, e.g., an ordered number of triples of the form

<scenario, sensor values, error values>

may be determined. On this basis, a correction of the measured values of the sensor may optionally be undertaken, e.g., by adding an offset to the sensor values or linking the sensor values to another representation.
Merging the measured values and determining a list of merged values for each of the scenarios and for the plurality of sensors, using a second program. The merging of the measured values results in so-called object generation. The objects are an equivalent to objects of the real world, e.g., roads, buildings, other vehicles. Thus, the object generation is occasionally referred to as a world simulation, as well. In this context, objects and the associated object attributes may also be formed with the aid of sequences of data of individual sensors.
For each merged value, determining a list of corresponding merging errors, using a third program.

The determination of the merging errors may also be used to generate a replacement list, in which the (erroneous), original measured values of the sensors are replaced by corrected, measured values, and these continue to be used.
Determining a corrected, merged value for each of the scenarios with the aid of a fourth program.

This agglomeration of the values allows a correct scenario to be detected, even in the case of erroneous sensor values, and the correct conclusions to be made and, in some instances, actions to be taken, e.g., the operation of predefined actuators.

In one specific embodiment, the corrected, merged value is used as a basis for the control of actuators of the vehicle.

In one specific embodiment, the first program determines the error values for each of the scenarios with the aid of heuristics. The heuristics may be derived, e.g., from empirical values, from tables or by manual input, e.g., by trained people. In addition, manual labeling methods may be used, in which human workers generate the reference label of the surrounding area from image data of the surrounding area of the ego vehicle and/or visualizations of the non-image-based sensor data.

In one specific embodiment, the first program determines the error values for each of the scenarios with the aid of reference sensors. Such reference sensors have a higher measuring accuracy than the sensors, which determine the above-mentioned measured values. These sensors may either be mounted in or on the vehicle or installed externally at specially equipped proving grounds or test tracks.

In one specific embodiment, for each of the scenarios, the first program determines the error values, using data, in particular, using reference data from other vehicles. This may be implemented, for example, with the aid of the so-called hunter-rabbit method. In this method, both the vehicle to be evaluated (hunter) and one or more other vehicles (rabbits) are equipped with a highly precise, e.g., satellite-aided, position detection system and further sensors (GNSS/IMU), as well as with a communications module. In this connection, the target vehicles continuously transmit their position, movement and/or acceleration values to the vehicle to be evaluated, which records its own values and the other values.

In one specific embodiment, the first program determines the error values with the aid of algorithmic methods, which compute the reference data from a plurality of sensor data and database data.

In one specific embodiment, the first program determines the error values for each of the scenarios, using map data, in particular, using highly precise map data. In the case of particular, highly precise map data, the static environment is stored. During the determination of the error values, the vehicle to be evaluated locates itself within this map.

In one specific embodiment, the first program uses a combination of the above-mentioned methods for determining the error values.

In one specific embodiment, the control system further includes a fifth program, which is set up to determine a category for each of the scenarios. Consequently, on one hand, the efficiency of the access to the measured values and error data may be increased further. On the other hand, the control system may be configured to be more robust, since in this manner, for example, particular data for particular scenarios may be sorted out as implausible, and consequently, a number of wrong decisions may be prevented.

The present invention also includes use of the above-mentioned control systems and methods for controlling vehicles, in particular, highly automated and/or partially automated vehicles.

Furthermore, the present invention includes use of the list of scenarios, in order to conduct regression tests for a plurality of sensors, in particular, of vehicles traveling in an at least partially automated manner.

A device is specified, which is configured to implement one of the above-described methods. Using such a device, the corresponding method may easily be integrated into different systems.

According to a further aspect, a computer program is specified, which includes commands that, in response to the execution of the computer program by a computer, cause it to execute one of the above-described methods. Such a computer program allows the described method to be used in different systems.

A machine-readable storage medium is specified, in which the above-described computer program is stored.

Exemplary embodiments of the present invention are depicted with reference to FIGS. 1 through 8 and explained in greater detail in the following.

### BRIEF DESCRIPTION OF THE DRAWINGS

FIG. 1 shows a simulation of a traffic situation from the point of view of an ego vehicle.

FIG. 2a shows an example of a first error model including an x- and a y-position of an object.

FIG. 2b shows an existence probability for the first error model.

FIG. 2c shows autocorrelation values for the first error model.

FIG. 3a shows an example of a second error model including an x- and a y-position of an object.

FIG. 3b shows an existence probability for the second error model.

FIG. 3c shows autocorrelation values for the second error model.

FIG. 4a shows a relative position in the x-direction in the event of the cutting-in of another vehicle.

FIG. 4b shows a relative velocity in the x-direction in the event of the cutting-in of another vehicle.

FIG. 4c shows a relative acceleration in the x-direction in the event of the cutting-in of another vehicle.

FIG. 5a shows a relative position in the y-direction in the event of the cutting-in of another vehicle.

FIG. 5b shows a relative velocity in the y-direction in the event of the cutting-in of another vehicle.

FIG. 5c shows a relative acceleration in the y-direction in the event of the cutting-in of another vehicle.

FIG. 6 shows a data flow of the method.

FIG. 7 shows an example of a list of scenarios.

FIG. 8 shows an example of a method for quantitatively characterizing at least one temporal sequence of an object attribute error.

### DETAILED DESCRIPTION

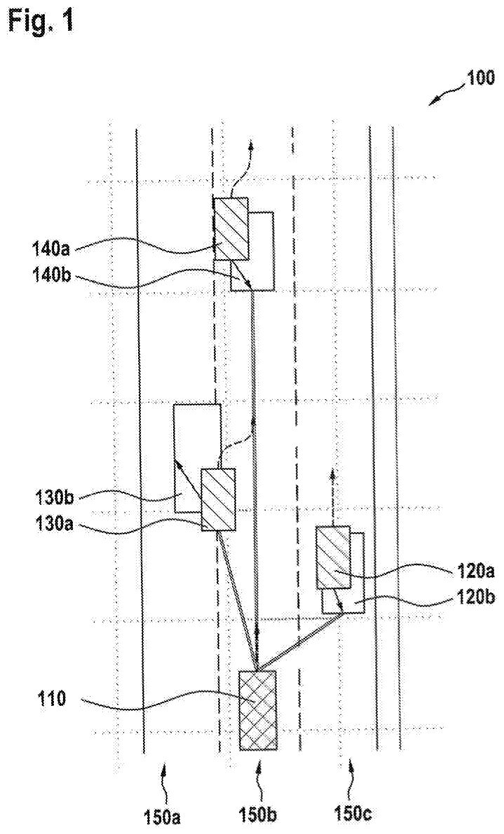

FIG. 1 shows an example of a driving situation in a simulation; realistic error contributions being superposed on the objects of the surrounding area, in this case, vehicles. The ego vehicle 110, which is also controlled by the original vehicle software in the simulation, is traveling on a center lane 150b of three lanes 150a, 150b, 150c. For these vehicles, the simulation specifies object attributes regarding the position of other vehicles 120a, 130a, 140a, via the sensor data. The travel path of ego vehicle 110 is determined to be straight ahead, e.g., by the sensors of the steering system.

From the retrieved sensor data for ego vehicle 110, the object attributes of a first other vehicle 120a yield a position 120a as traveling in right lane 150c. For the simulation, superposing the error contribution on the object attributes yields, for example, for the simulation, non-hatched surface 120b for the object attributes, in accordance with a realistic error.

A past (history) of the data may be used for further correcting the position of other vehicle 102a and, in addition, for estimating the travel path of the first other vehicle. The positions of further, other vehicles 130a, 140a, as well as their object attributes acted upon by an error contribution, with respect to positions 130b and 140b, are derived in an analogous manner.

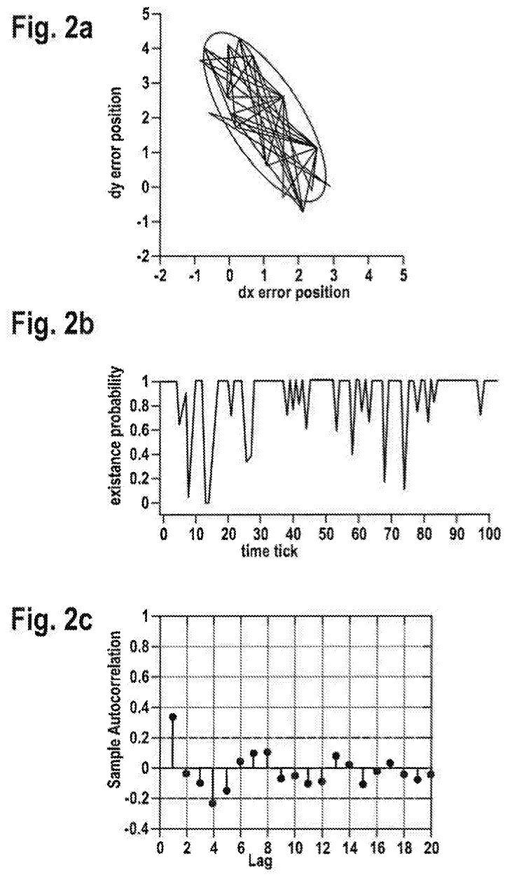

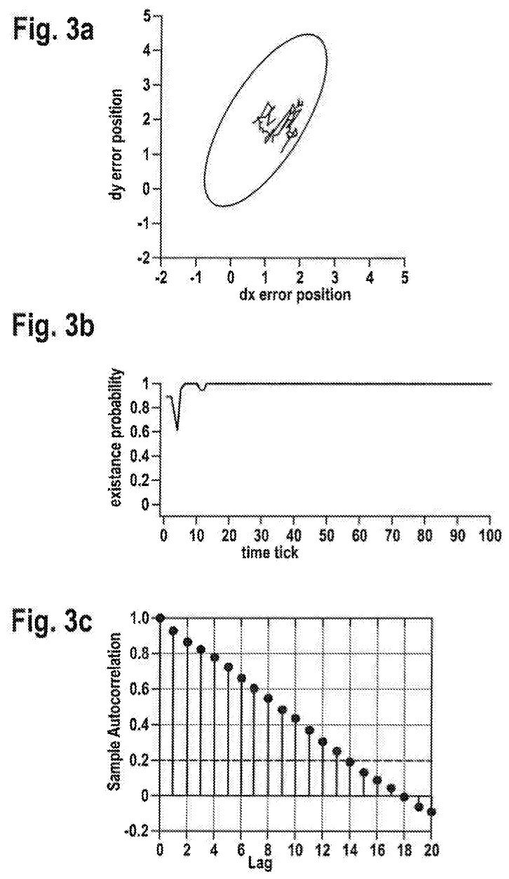

FIGS. 2 and 3 compare a simulated example for, in each instance, a first and a second coupled, 3-dimensional error model of an object attribute error at both the x- and y-positions, as well as with regard to an existence probability of an object. The x-position error, y-position error and the existence probability were generated for the first and the second model, from error models coupled completely differently. The first model of lower autocorrelation corresponding to 1 time step; the second model having higher autocorrelation, corresponding to 14 time steps. The amplitudes of the 2 models were generated from different probability densities, as well, using two Gaussian functions correlated differently. In this context, however, any desired probability densities are possible.

The random walker used is a standard Metropolis-Hastings algorithm. Alternatively, arbitrary, even hybrid, Monte Carlo methods, which have weak convergence to the target distribution, would be possible.

The adjustment of the autocorrelation was achieved by thinning out the samples. Alternatively, adaptations of the Monte Carlo method would also be possible.

The comparison of FIGS. 2a and 3a shows how different these error models are with regard to the error in the x- and y-directions, and the comparison of FIGS. 2b and 3b shows the difference in the existence probability. The respective autocorrelation functions of error sequences 2c and 3c also indicate large differences, which may be reflected, using this error model. In this instance, the Gaussian distribution is only illustrative. Error models may have any desired density distributions (shapes); in particular, highly fragmented shapes are also conceivable.

In this context, the first error model of FIG. 2a is configured, such that a sequence of the error of the x- and the y-positions shows highly sharp variations in amplitude, and that the error of the x-position is negatively correlated with the error of the y-position.

In comparison, the model of FIG. 3a shows a slow change in an error position and a positive correlation. The comparison of the existence probabilities of the two models shows that in the first model of FIG. 2b, the existence is highly uncertain and also does not stabilize. In the second error model, after a transient oscillation, the existence is highly constant at practically one, as illustrated in FIG. 3b.

These differences of the two models are also evident in the comparison of the autocorrelation functions 2c and 3c. According to FIG. 2c, the first model shows practically no correlation within the series of error data, whereas the second model according to FIG. 3c has a high autocorrelation beyond the tenth time step.

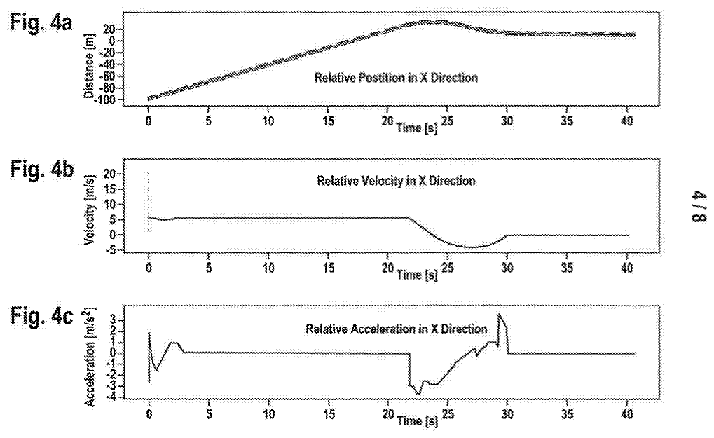

In FIG. 4a through c, simulated object attributes with regard to an x-direction of a vehicle, are shown over a time axis, when another vehicle cuts in front of the ego vehicle.

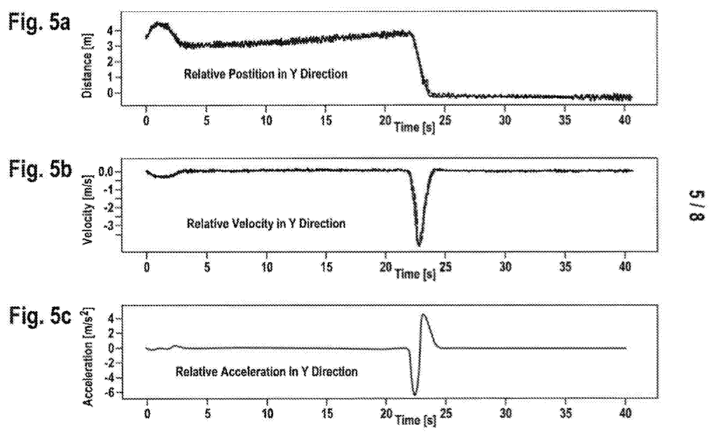

In FIG. 5a through c, simulated object attributes with regard to a y-direction of a vehicle are shown over the same time axis, when another vehicle cuts in front of the ego vehicle.

In this context, the specific graphs show a) a position; b) a velocity; and c) an acceleration in the specific directions. A comparison of the graphs of FIG. 4 with the graphs of FIG. 5 shows that, in particular, the error in the determination of the position in the y-direction is much larger than the error in the relative position in the x-direction. This is no longer quite so sharply pronounced for the relative velocity in the x- and y-direction.

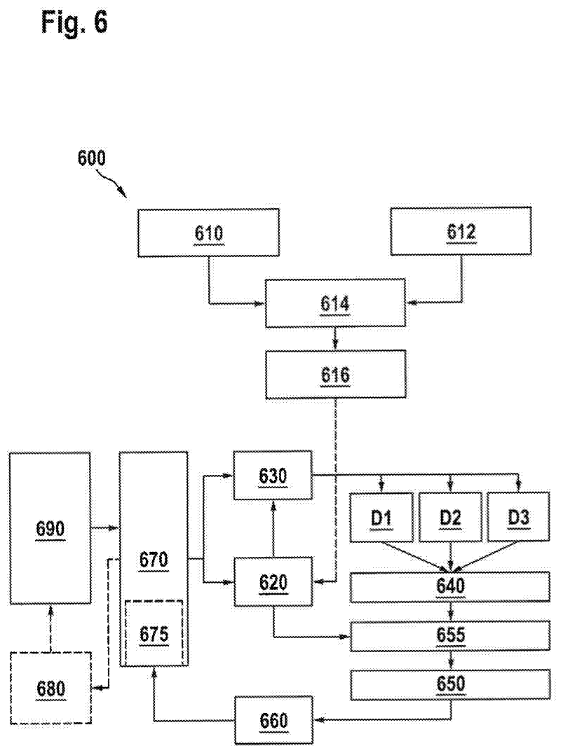

FIG. 6 shows an example of a simulation system 100, including a control system 100 for a vehicle 400 (not shown).

Before a simulation is carried out by simulation system 100, an error model is generated for different sensor types in different scenarios. To that end, sequences of sensor data 110, in addition, or alternatively, sequences of object attributes 110 of objects of a plurality of sensors 201, 202, 203, which may each represent a different sensor type, are transmitted to a statistics module 114.

Sequences of object attributes 110 of objects may be determined both, using sensor data 110 of a single sensor of a certain sensor type and by merging sequences of sensor data of a plurality of sensors, in particular, of different sensor types, as well.

In addition, or alternatively, these sensor data 110 or object attributes 110 may be generated during a trip of a vehicle, which has the plurality of sensors 201, 202, 203. In statistics module 114, for example, with the aid of a first program P1, sensor data 110 or object attributes 110 are compared to correction data 112 or ground-truth object attribute data 112 of the objects, which are to the plurality of sensors 201, 202, 203, for example, on the basis of a list of values in a database. Statistics module 114 creates error models for generating temporal sequences of error contributions for object attribute data 112 of the objects, which have been generated either from sequences of sensor data of individual sensors, for different scenarios, or by merging sequences of sensor data of a plurality of sensors 201, 202, 203 for different scenarios.

For a simulation, these error models 120 may be linked to a world model 170. Error models 120 of the plurality of sensors 201, 202, 203 are either transmitted via sensor interface 130 to the plurality of sensors 201, 202, 203 and are used for superposing sequences of error contributions onto the object attributes of objects, which have been generated to have measured values M201, M202, M203 of the simulated sensor data, as a function of the scenario currently simulated.

Alternatively, the sequences of error contributions are superposed 155 onto the object attributes of the merged sensor data after the merging 140 of the sensor data of the plurality of sensors 201, 202, 203, as a function of the scenario currently simulated.

With the aid of the sensor data, a merged value 140 is determined by a second program P2, that is, the object attributes of objects are determined, which have been detected by the plurality of sensors. Merged value 140 may be a list of values, which determine a merged value T1, T2 and, with the aid of a third program P3, an error value U1, U2 and a corrected value Y1, Y2, from the measured values M201, M202, M203 of the plurality of sensors 201, 202, 203, for each of scenarios S1, S2. In one specific embodiment, the category K1, K2 is additionally determined.

Merged value 140 is determined with the aid of a second program P2. Merged value 140 is then linked to error models 120 in a merging interface 155, in order to consequently represent the world simulation more realistically, by superposing sequences of error contributions onto merged values scenario-dependently, which have been determined with the aid of synthetic sensor values.

The plurality of scenarios S1, S2 may be controlled in a simulation by controller 190; in real vehicles, this is determined by the travel path in a real environment. Even more modules 150, of which one, for example, controls actuator interface 160, may be provided in simulation system 100.

In real vehicles, actuator interface 160 controls the actuators; in a simulation, a vehicle model 175. Vehicle model 175 may be part of a world model 170. World model 170 controls sensor interface 130 and error models 120. In a simulation, the outputs are transmitted to an output module 180; in real vehicles, a portion of the outputs is transmitted to indicators in the vehicle.

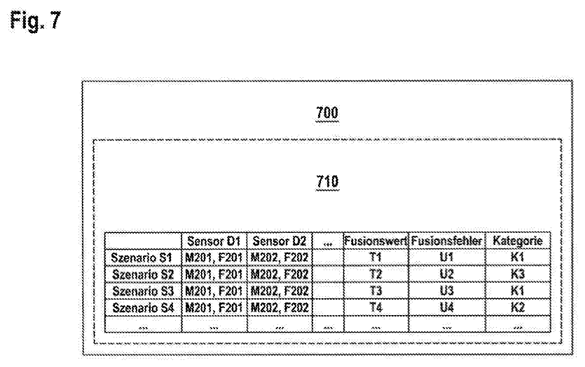

FIG. 7 shows an example of a list of scenarios. The list of scenarios is stored in a memory 310 of a computer system 300.

For reasons of capability of representation, the case of four scenarios S1 through S4 is depicted, using two sensors 201 and 202. For scenario S1, measured value M201(S1) is ascertained and error value F201(S1) is determined by sensor 201; measured value M202(S1) and error value F202(S1) are determined by sensor 202. In a corresponding manner for scenarios S2 through S4. From this plurality of sensor data, a second program P2 determines, for each scenario, a merged value, a merging error, a corrected value and, in one specific embodiment, a category. In this manner, values T1, U1, Y1, K1 are determined for scenario S1.

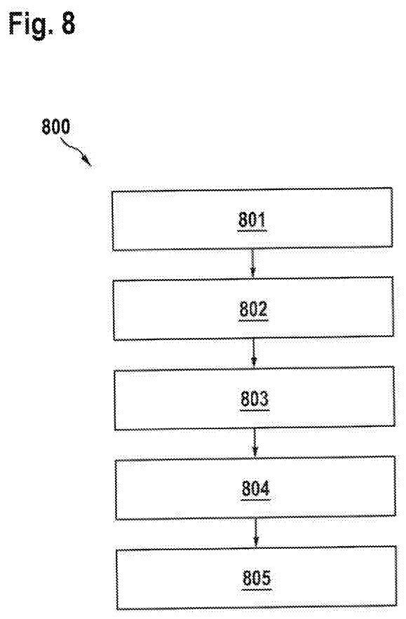

FIG. 8 shows an example of a method 800 for controlling a vehicle with the aid of a control system 100. In step 801, a list of scenarios S1, S2 (see FIG. 7) is generated and stored in a memory.

In step 802, for each of scenarios S1, S2, measured values M201, M202 are determined with the aid of a plurality of sensors, and in addition, corresponding error values F201, F202 are determined with the aid of a first program P1. On this basis, a correction of measured values M201, M202 of sensors 201, 202 may optionally be undertaken, e.g., by adding an offset to the sensor values or linking the sensor values to another mapping.

In step 803, the measured values are merged and a list of merged values is determined with the aid of a second program P2, for each of scenarios S1, S2 and for the plurality of sensors 201, 202. The merging of the measured values results in so-called object generation. The objects are an equivalent to objects of the real world, e.g., roads, buildings, other vehicles.

In step 804, a list of corresponding merging errors U1, U2 is determined for each merged value with the aid of a third program. The determination of the merging errors may also be used to generate a replacement list, in which the (erroneous), original measured values of the sensors are replaced by corrected, measured values, and these continue to be used.

In step 805, a corrected, merged value is determined for each of the scenarios with the aid of a fourth program.

1-15. (canceled)

16. A method for quantitatively characterizing at least one temporal sequence of an object attribute error of an object, for at least one scenario of a plurality of scenarios, the object having been detected by at least one sensor of a plurality of sensors, the method comprising:
providing at least one temporal sequence of sensor data of a plurality of temporal sequences of sensor data of the at least one sensor, for the at least one scenario;
determining at least one temporal sequence of at least one object attribute of the object with the aid of the at least one temporal sequence of sensor data;
providing a sequence of a reference object attribute of the object of the scenario, corresponding to the temporal sequence of the object attributes;
determining a sequence of object attribute difference by comparing the sequence of the object attribute to the sequence of the reference object attribute of the object for the scenario; and
generating an error model with the aid of the temporal sequence of the object attribute difference, to describe temporal sequences of object attribute errors of objects for the scenario;
the object having been detected by the at least one sensor, to quantitatively characterize the object attribute error.

17. The method of claim 16, wherein a time base of the at least one temporal sequence of at least one object attribute of the object and a time base of the temporal sequence of a reference object attribute, corresponding to the temporal sequence of the object attributes, are adapted to each other prior to the determination of the object attribute difference, in order to form the difference.

18. The method of claim 16, wherein the object has been detected by a plurality of sensors, further comprising:
providing at least one temporal sequence of a plurality of temporal sequences of sensor data of each sensor of the plurality of sensors, for the at least one scenario;
determining at least one temporal sequence of at least one object attribute of the object with the aid of the at least one temporal data sequence of each sensor of the plurality of sensors;
merging the resulting plurality of temporal sequences of the object attributes of the object with the aid of the individual object attributes of the plurality of sensors;
providing a sequence of a reference object attribute of the object of the scenario, corresponding to the temporal sequence of the object attributes;
determining a sequence of an object attribute difference by comparing the sequence of the merged object attributes to the sequence of the reference object attributes of the objects for the scenario; and
generating an error model with the aid of the sequence of the merged object attribute difference, to describe temporal sequences of the object attribute errors of objects for the scenario, wherein the object has been detected by the plurality of sensors, so as to quantitatively characterize the object attribute error.

19. The method of claim 16, wherein the provided, associated sequence of reference object attributes of the object of the scenario is generated with manual labeling methods and/or reference sensors and/or hunter-rabbit methods and/or algorithmic methods for generating reference data, including holistic generation of reference labels, and/or highly precise map data.

20. The method of claim 16, wherein at least one scenario of the plurality of scenarios is divided up into categories typical of a scenario, and each category is assigned a corresponding error model.

21. The method of claim 19, wherein the scenarios include sub-scenarios, and the categories are assigned to the scenarios and sub-scenarios in such a manner, that the categories are encoded in an associable manner.

22. The method of claim 16, wherein the error model is configured to generate temporal sequences of the object attribute errors specifically for scenarios of a plurality of scenarios having a temporal amplitude behavior of the sequence of the object attribute difference and/or a correlation behavior of the sequence of the object attribute difference and/or a dynamic behavior of the sequence of the object attribute difference.

23. The method of claim 16, wherein the error model generates the temporal sequence of the object attribute error for a scenario, using a statistical method, in which with the aid of a probability density and a random walker, a sequence of object attribute errors is generated on the probability density; and by thinning out the temporal sequence of object attribute errors, the autocorrelation length is adapted to the sequence of the object attribute difference; and with the aid of a density estimator and a plurality of temporal sequences of object attribute differences of a plurality of different object attributes of the scenario, the probability density common to the plurality of object attributes is generated.

24. The method of claim 16, wherein the error model is configured to generate temporal sequences of an existence probability of at least one object of the surrounding area.

25. The method of claim 22, wherein the method is for validating a vehicle control system in a simulation, using at least one scenario of a plurality of scenarios in a simulation environment, which includes at least one object, further comprising:
providing at least one temporal sequence of sensor data of at least one sensor for a representation of the at least one object, in accordance with the scenario;
determining a temporal sequence of at least one object attribute of the at least one object with the aid of the at least one temporal sequence of the sensor data;
providing an error model of the at least one sensor in accordance with a type of the at least one sensor, and in accordance with the scenario;
generating a temporal sequence of an object attribute error, using the error model for the at least one object attribute of the at least one object;
superposing the temporal sequence of the object attribute error on the temporal sequence of the at least one object attribute of the at least one object;
providing the temporal sequence of the at least one object attribute, including the superposed error contribution for the vehicle control system, to validate the vehicle control system in the scenario.

26. The method of claim 22, wherein for validating a vehicle control system in a vehicle, in a surrounding area that includes at least one object, further comprising:
determining at least one temporal sequence of sensor data of at least one reference sensor, in order to detect the at least one object of the surrounding area;
determining a temporal sequence of at least one object attribute of the at least one object with the aid of the at least one temporal sequence of the sensor data;
identifying the scenario of the surrounding area of the vehicle with the aid of the at least one temporal sequence of the sensor data;
providing an error model in accordance with a type of a test sensor, and in accordance with the identified scenario;
generating a temporal sequence of an object attribute error, using the error model for the at least one object attribute of the at least one object;
superposing the temporal sequence of the object attribute error on the temporal sequence of the at least one object attribute of the at least one object; and
providing the temporal sequence of the at least one object attribute, including the superposed error contribution for the vehicle control system, to validate the vehicle control system in the vehicle.

27. A simulation system for a control system of a vehicle, comprising:
a computer system having a memory, wherein a list of scenarios is stored in the memory; and
a plurality of sensors; each of the sensors being configured to transmit a measured value to the memory, and wherein for each of the scenarios and for each of the sensors, a first program is set up to assign the corresponding measured value and to determine a corresponding error value;
wherein a second program is set up to determine a merged value for each of the scenarios, from the measured values of the plurality of sensors, and
wherein a third program is set up to determine a corresponding merging error for each of the merged values.

28. An apparatus, comprising:
a device for quantitatively characterizing at least one temporal sequence of an object attribute error of an object, for at least one scenario of a plurality of scenarios; the object having been detected by at least one sensor of a plurality of sensors, and configured to perform the following:
providing at least one temporal sequence of sensor data of a plurality of temporal sequences of sensor data of the at least one sensor, for the at least one scenario;
determining at least one temporal sequence of at least one object attribute of the object with the aid of the at least one temporal sequence of sensor data;
providing a sequence of a reference object attribute of the object of the scenario, corresponding to the temporal sequence of the object attributes;
determining a sequence of object attribute difference by comparing the sequence of the object attribute to the sequence of the reference object attribute of the object for the scenario;
generating an error model with the temporal sequence of the object attribute difference, to describe temporal sequences of object attribute errors of objects for the scenario; the object having been detected by the at least one sensor, to quantitatively characterize the object attribute error.

29. A non-transitory computer readable medium having a computer program, which is executable by a processor, comprising:
a program code arrangement having program code for quantitatively characterizing at least one temporal sequence of an object attribute error of an object, for at least one scenario of a plurality of scenarios; the object having been detected by at least one sensor of a plurality of sensors, by performing the following:
providing at least one temporal sequence of sensor data of a plurality of temporal sequences of sensor data of the at least one sensor, for the at least one scenario;
determining at least one temporal sequence of at least one object attribute of the object with the aid of the at least one temporal sequence of sensor data;
providing a sequence of a reference object attribute of the object of the scenario, corresponding to the temporal sequence of the object attributes;
determining a sequence of object attribute difference by comparing the sequence of the object attribute to the sequence of the reference object attribute of the object for the scenario;
generating an error model with the aid of the temporal sequence of the object attribute difference, to describe temporal sequences of object attribute errors of objects for the scenario; the object having been detected by the at least one sensor, to quantitatively characterize the object attribute error.

30. The computer readable medium of claim 29, wherein a time base of the at least one temporal sequence of at least one object attribute of the object and a time base of the temporal sequence of a reference object attribute, corresponding to the temporal sequence of the object attributes, are adapted to each other prior to the determination of the object attribute difference, in order to form the difference.
